(19) United States
(12) Patent Application Publication
(10) Pub. No.: US 2018/0097697 A1
(43) Pub. Date: Apr. 5, 2018

(54) SYSTEMS AND METHODS FOR PROVIDING ADAPTIVE EXPERIMENTATION OF CONTEXTUAL CONFIGURATIONS IN A SOCIAL NETWORKING SYSTEM

(71) Applicant: Facebook, Inc., Menlo Park, CA (US)

(72) Inventors: Eytan Bakshy, San Francisco, CA (US); Amir Rosenfeld, Sunnyvale, CA (US); Linbin Yu, Union City, CA (US); Alexandru Petrescu, Shoreline, WA (US); Konstantin Kashin, San Francisco, CA (US)

(21) Appl. No.: 15/285,185

(22) Filed: Oct. 4, 2016

(51) Int. Cl. H04L 12/24

(52) U.S. Cl. CPC H04L 41/0823; H04L 41/0859

(57) ABSTRACT

Systems, methods, and non-transitory computer readable media can determine a first plurality of configurations associated with a context relating to users. A respective first weight for each configuration of the first plurality of configurations that reflects a probability of the configuration improving performance associated with a metric can be determined. Each configuration of the first plurality of configurations can be randomly assigned to a proportion of a first group of users that corresponds to the respective first weight. Performance data of the first plurality of configurations associated with the metric can be obtained.

### FIELD OF THE INVENTION

The present technology relates to the field of social networks. More particularly, the present technology relates to techniques for providing adaptive experiments associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system may provide user profiles for various users through which users may add connections, such as friends, or publish content items. A content item can be presented on a profile page of a user. A content item can also be presented through a feed, such as a newsfeed, for a user to view and access.

### SUMMARY

Various embodiments of the present disclosure can include systems, methods, and non-transitory computer readable media configured to determine a first plurality of configurations associated with a context relating to users. A respective first weight for each configuration of the first plurality of configurations that reflects a probability of the configuration improving performance associated with a metric can be determined. Each configuration of the first plurality of configurations can be randomly assigned to a proportion of a first group of users that corresponds to the respective first weight. Performance data of the first plurality of configurations associated with the metric can be obtained.

In some embodiments, a second plurality of configurations associated with the context can be determined based on the obtained performance data of the first plurality of configurations. A respective second weight for each configuration of the second plurality of configurations that reflects a probability of the configuration improving performance associated with the metric can be determined based on the obtained performance data of the first plurality of configurations. Each configuration of the second plurality of configurations can be randomly assigned to a proportion of a second group of users that corresponds to the respective second weight. Performance data of the second plurality of configurations associated with the metric can be obtained.

In certain embodiments, the context is associated with a parameter and a value of the parameter is selected from a plurality of possible values.

In an embodiment, a plurality of categories is associated with the context, and a configuration specifies a value of the parameter for each of the plurality of categories associated with the context.

In some embodiments, the first plurality of configurations is a subset of configurations that are possible based on the plurality of possible values of the parameter for each of the plurality of categories associated with the context.

In certain embodiments, the second plurality of configurations is a subset of configurations that are possible based on the plurality of possible values of the parameter for each of the plurality of categories associated with the context, and the second plurality of configurations is different from the first plurality of configurations.

In an embodiment, a constraint associated with the parameter identifies a subset of configurations that are possible based on the plurality of possible values of the parameter for each of the plurality of categories associated with the context, and the first subset of configurations is selected from the identified subset.

In some embodiments, the context for a user in the first group of users can be resolved by associating the user with one of the plurality of categories associated with the context and assigning to the context the value of the parameter for the associated category specified in the configuration assigned to the user.

In certain embodiments, the obtained performance data of the first plurality of configurations associated with the metric can be analyzed based on a statistical model.

In an embodiment, the context relates to one or more of: a geographical region of a user, a network connection quality of a user, or a device of a user.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example adaptive experiment module configured to provide adaptive experiments associated with a social networking system, according to an embodiment of the present disclosure.

FIG. 2 illustrates an example experiment performance module configured to perform adaptive experiments associated with a social networking system, according to an embodiment of the present disclosure.

FIG. 3A illustrates an example scenario for providing configurations associated with contexts, according to an embodiment of the present disclosure.

FIG. 3B illustrates an example scenario for providing adaptive experiments associated with a social networking system, according to an embodiment of the present disclosure.

FIG. 4 illustrates an example first method for providing adaptive experiments associated with a social networking system, according to an embodiment of the present disclosure.

FIG. 5 illustrates an example second method for providing adaptive experiments associated with a social networking system, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Adaptive Experimentation of Contextual Configurations in a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide user profiles for various users through which users may add connections, such as friends, or publish content items. A content item can be presented on a profile page of a user. A content item can also be presented through a feed, such as a newsfeed, for a user to view and access.

Many parameters can be defined and used in a social networking system. For example, there can be parameters associated with users, devices of users, applications, etc. In one example, a parameter for number of content items to fetch for users' feeds can be defined. When users access an application associated with the social networking system, content items can be fetched for the users' feeds based on the value of the parameter for the number of content items to fetch. Conventional approaches specifically arising in the realm of computer technology can provide a single value for a parameter, for example, without considering contexts relating to the parameter. For example, the same number of content items can be fetched for users' feeds based on the single value of the parameter for number of content items to fetch. However, providing a single value for a parameter may not take into account information that can help improve or optimize performance. For example, the number of content items to fetch can vary depending on a user's network connection quality, and determining the number of content items to fetch based on the user's network connection quality can improve download performance of content items. However, conventional approaches may provide a single value for the parameter for the number of content items to fetch, for example, an average value for all users without considering users' network connection quality.

An improved approach rooted in computer technology can overcome the foregoing and other disadvantages associated with conventional approaches specifically arising in the realm of computer technology. Based on computer technology, the disclosed technology can provide parameters that can have different values based on contexts associated with the parameters. For example, a context can indicate any state or characteristic that can be used to distinguish users. For the parameter for the number of content items to fetch, examples of a context associated with the parameter can include a user's network connection quality, a user's country, etc. One or more categories can be defined for a context, and different values of the parameter can be assigned to the categories of the context. For example, the network connection quality context can have a first category for excellent network connection quality, a second category for good network connection quality, a third category for moderate network connection quality, and so forth. Each category for the network connection quality context can be assigned a value for the parameter. A value of a category for a context can be selected from a range of values or a set of possible values. Accordingly, there can be many possible combinations of values of categories for a context of a parameter. Each combination of values of categories for a context can be referred to as a configuration. Certain configurations can be more effective than other configurations, for example, with respect to a metric associated with or relevant to the parameter.

Accordingly, the disclosed technology can provide an adaptive experiment to determine which configurations for a context of a parameter are likely to be effective in an efficient manner. An adaptive experiment can be associated with an objective, which can be described in terms of a metric that can be optimized. The adaptive experiment can be performed in sequence in multiple sessions over time. Each session can include a subset of users of a relevant user population for the adaptive experiment. Each session can test a subset of possible configurations with users for the session. There can be many possible configurations, and the subset of configurations can be generated randomly. Configurations in the subset can be assigned to the users for the session based on weights associated with the configurations. A weight associated with a configuration can indicate a probability of the configuration improving the metric. The weights associated with the configurations can be set to equal values in the initial session. Each configuration in the subset can be randomly assigned to a proportion of the users for the session that corresponds to the weight associated with the configuration. Performance data relating to the metric can be obtained and analyzed for the configurations in the subset. For example, the performance data can be fit to a statistical model. Based on the performance data, a new subset of configurations can be generated for a subsequent session, and weights associated with configurations in the new subset can be determined. Each configuration in the new subset can be randomly assigned to a proportion of users for the subsequent session that corresponds to the weight associated with the configuration. The process can be repeated until certain conditions are satisfied. For example, the process can be repeated until all users of the relevant user population have been included in the adaptive experiment. Details relating to the disclosed technology are explained further below.

In this manner, the disclosed technology can provide an experiment that is adaptive for testing configurations of a context associated with a parameter. Configurations that are more likely to improve a metric associated with the parameter can be tested in each session based on performance data of the metric for tested configurations in a previous session. Also, weights for configurations in a session can be determined based on the performance data to reflect a probability of each configuration improving the metric. In this way, configurations that have a higher probability of improving the metric can be provided to a higher proportion of users over time. The disclosed technology can determine effective configurations of a context while increasingly improving user experience over time. In addition, the disclosed technology can test a small subset of all possible configurations to determine effective configurations. By allowing different values for a parameter based on related contexts, the disclosed technology can provide a more customized experience for users.

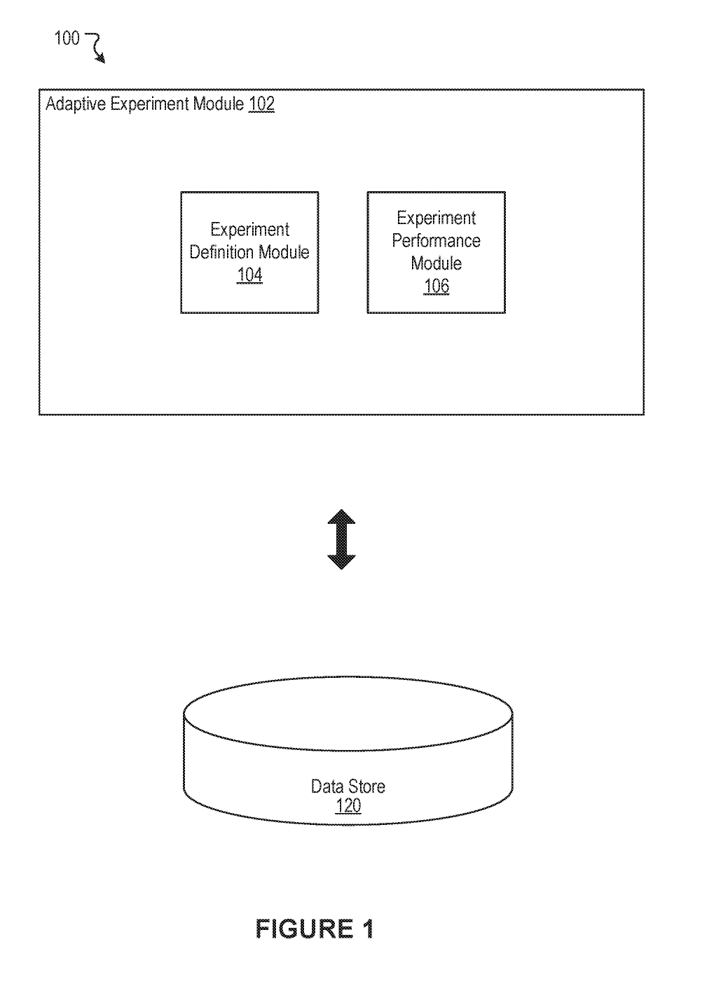

FIG. 1 illustrates an example system 100 including an example adaptive experiment module 102 configured to provide adaptive experiments associated with a social networking system, according to an embodiment of the present disclosure. The adaptive experiment module 102 can include an experiment definition module 104 and an experiment performance module 106. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the adaptive experiment module 102 can be implemented in any suitable combinations.

The experiment definition module 104 can define various settings associated with an adaptive experiment. An adaptive experiment can be designed to explore various configurations associated with contexts for parameters. The experiment definition module 104 can provide a user interface for defining various settings associated with an adaptive experiment. The settings associated with an adaptive experiment can include parameters, contexts associated with parameters, an objective, etc. Parameters can represent or indicate any information for which values can be determined and used in the social networking system. For example, values of parameters can be determined and used at runtime. Examples of parameters can include a number of content items to fetch for a feed, an amount of data to fetch for a feed, a feed inventory, a delay in logging data, etc. Many variations are possible. A parameter can have a name associated with it. A parameter can also have a type associated with it (e.g., integer, string, float, etc.). A parameter can have a value that is selected from a range of values, a set of possible values (e.g., discrete values), etc. Examples of a value can include a number, a letter, a word, etc. A parameter can have a default value. There can be one or more constraints associated with parameters. Constraints associated with parameters can specify relationships between parameters. For example, a constraint can specify that a value of a first parameter should be greater than a value of a second parameter.

The settings associated with an adaptive experiment can include contexts associated with parameters. A context associated with a parameter can indicate any state or characteristic that can be used to distinguish users. Examples of a context associated with a parameter can include a user's network connection quality, a user's age or age range, a user's region (e.g., country, state, county, city, etc.), a user's device capacity (e.g., memory, storage, processor, etc.), etc. Many variations are possible. One or more categories can be defined for a context. A context can be used to distinguish users, and users can be associated with a particular category of a context based on certain criteria, values, etc. For example, if a context associated with a parameter is a user's network connection quality, categories of the network connection quality context can include an “excellent” network connection quality category, a “good” network connection quality category, a “moderate” network connection quality category, and a “poor” network connection quality category. In the above example, each of the four categories can have associated criteria relating to network connection quality, and a user can be associated with one of the four categories based on the criteria associated with the category and the user's network connection quality. Each category of a context can be represented by a number, a text, etc. Each category of a context can be assigned a value for a parameter with which the context is associated. As explained above, examples of a value for a parameter can include a number, a letter, a word, etc., and a value for a parameter can be selected from a range of values, a set of possible values (e.g., discrete values), etc. For example, the “excellent” category can be assigned a first value for a parameter with which the network connection quality context is associated, the “good” category can be assigned a second value for the parameter, and so forth. A value of a parameter assigned to a category of a context can be referred to as a “parameter value.” Since a parameter value assigned to a category can be selected from multiple possible values, there can be many different combinations of parameters values that can be assigned to categories of a context. A configuration can indicate a particular combination of parameter values assigned to categories of a context. Since configurations relate to a context associated with a parameter, such configurations can be referred to as “contextual configurations.”

In some cases, a context can be defined at a level that is higher than another context. For a context that is defined at a higher level than another context, one or more configurations associated with the other context can be assigned to a category of the context, instead of a parameter value. For example, a context for a user's country can be defined for a parameter at a higher level than the network connection quality context, and each category of the country context can be assigned one or more configurations associated with the network connection quality context. If categories of the country context include Country 1 and Country 2, Country 1 and Country 2 can each be assigned one or more configurations for the network connection quality context. For instance, different configurations of the network connection quality context can be assigned to Country 1 and Country 2. Two levels of contexts have been described for illustrative purposes, and there can be many variations and possibilities. For example, multiple levels of contexts can be defined, and multiple contexts can be defined at the same level. The number of levels of contexts and/or the number of contexts included in a level can be determined and adjusted as appropriate to perform an adaptive experiment in an efficient manner.

Types of contexts can include static contexts and dynamic contexts. After an adaptive experiment starts, contexts can be resolved for users included in the adaptive experiment. A context can be resolved by mapping the context to a particular parameter value or a particular set of configurations for each user. For example, a particular category of the context a user is associated with can be determined, and the context can be mapped to a parameter value or one or more configurations of the particular category for that user. Resolving contexts is explained in more detail below. A static context can refer to a context that can be resolved without referring to conditions at runtime. A dynamic context can refer to a context that can be resolved at runtime. The country context can be a static context since a user's country is generally unlikely to change. Accordingly, the country context can be mapped to configurations for a particular category of the country context without referring to runtime conditions. The network connection quality context can be a dynamic context. Since a user's network connection quality can change over time, a particular category of the network connection quality context with which a user is associated can also change over time. Accordingly, the network connection quality context can be mapped to a parameter value for a particular category of the network connection quality context at runtime in order to reflect a current network connection quality associated with the user. Static contexts can be resolved prior to dynamic contexts.

The settings associated with an adaptive experiment can also include an objective. An objective associated with an adaptive experiment can relate to a goal to be achieved for the adaptive experiment. An objective can be specified as one or more metrics, which can be optimized or maximized. For example, there can be a metric for number of likes, and an objective associated with an adaptive experiment can be to improve the metric for number of likes (e.g., increase the number of likes). Data relating to performance of one or more metrics associated with an adaptive experiment can be obtained for each session of the adaptive experiment. The performance data of the one or more metrics can be used to determine weights associated with configurations, as explained further below. There can be one or more constraints associated with an objective. Constraints associated with an objective can specify conditions that should be satisfied while a metric associated with an objective is being optimized. For example, a constraint can specify that a revenue should remain positive while the number of likes is increased. As another example, a constraint can specify that an amount of time spent using an application associated with the social networking system should not decrease while the number of likes is increased.

The settings associated with an adaptive experiment can also include other information or criteria. For example, a number of users to be included in a session of an adaptive experiment can be defined. The number of users can be indicated as a portion or a percentage of a relevant user population, by a number, etc. A number of sessions in an adaptive experiment can be determined based on the number of users included in a session. Targeting criteria for an adaptive experiment can also be defined. Targeting criteria can indicate characteristics associated with users, devices, and/or applications to be targeted by an adaptive experiment. For example, targeting criteria can specify information such as a country of a user, a type of device, a type of device OS, a version of a device OS, a version of an application, etc. Targeting criteria can be used to identify a relevant user population for an adaptive experiment. A number of configurations to be generated or tested for each session of an adaptive experiment can also be defined. All examples herein are provided for illustrative purposes, and there can be many variations and other possibilities.

The experiment performance module 106 can perform an adaptive experiment. For example, the experiment performance module 106 can start an adaptive experiment, generate random configurations, resolve contexts relating to configurations, assign users to configurations, obtain results of the adaptive experiment, etc. The experiment performance module 106 is described in more detail herein.

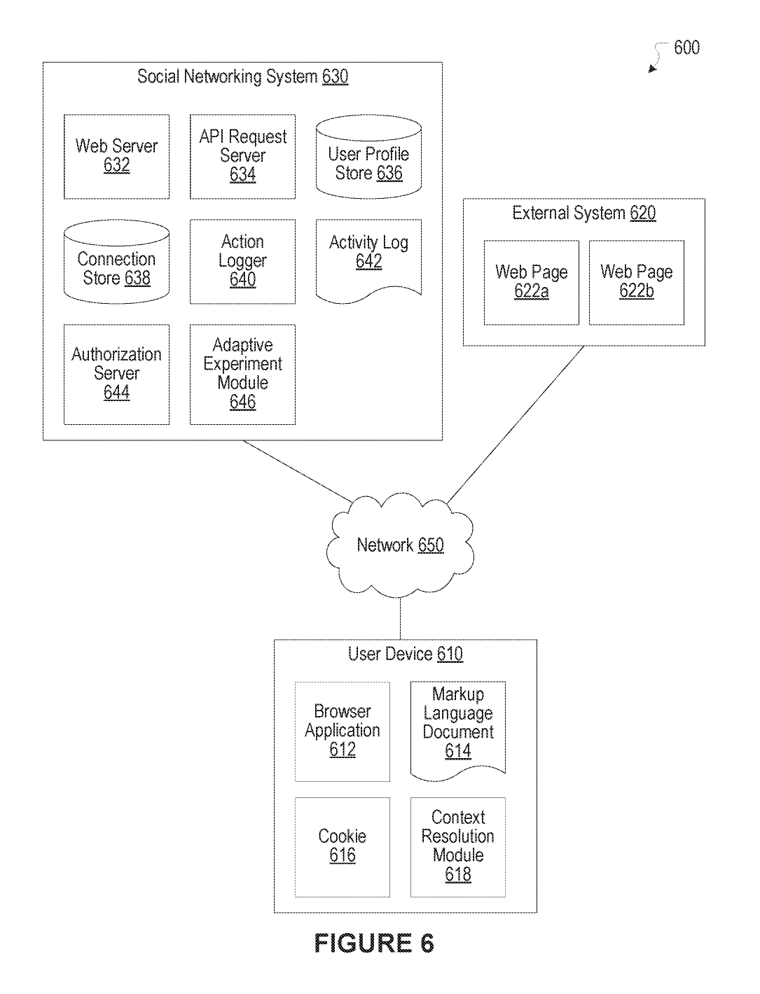

In some embodiments, the adaptive experiment module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the adaptive experiment module 102 can be, in part or in whole, implemented as software running on one or more computing devices or systems, such as on a server system or a client computing device. In some instances, the adaptive experiment module 102 can be, in part or in whole, implemented within or configured to operate in conjunction or be integrated with a social networking system (or service), such as a social networking system 630 of FIG. 6. Likewise, in some instances, the adaptive experiment module 102 can be, in part or in whole, implemented within or configured to operate in conjunction or be integrated with a client computing device, such as the user device 610 of FIG. 6. For example, the adaptive experiment module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the adaptive experiment module 102. The data maintained by the data store 120 can include, for example, information relating to adaptive experiments, settings associated with adaptive experiments, parameters, contexts associated with parameters, categories of contexts, objectives, metrics associated with objectives, constraints associated with parameters, constraints associated with objectives, configurations, weights associated with configurations, performance data associated with metrics, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the adaptive experiment module 102 can be configured to communicate and/or operate with the data store 120. In some embodiments, the data store 120 can be a data store within a client computing device. In some embodiments, the data store 120 can be a data store of a server system in communication with the client computing device.

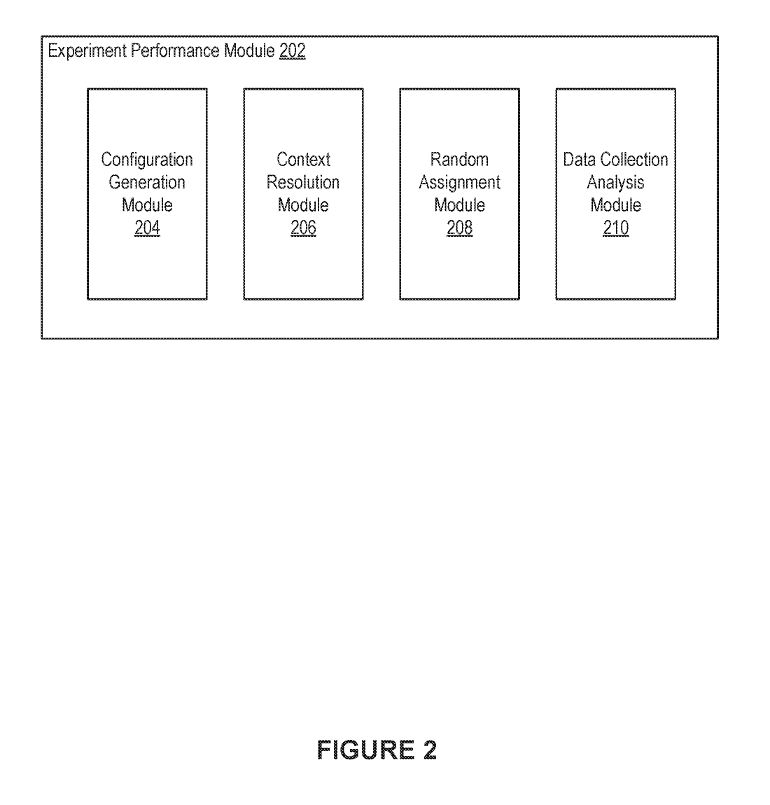

FIG. 2 illustrates an example experiment performance module 202 configured to perform adaptive experiments associated with a social networking system, according to an embodiment of the present disclosure. In some embodiments, the experiment performance module 106 of FIG. 1 can be implemented with the example experiment performance module 202. As shown in the example of FIG. 2, the example experiment performance module 202 can include a configuration generation module 204, a context resolution module 206, a random assignment module 208, and a data collection analysis module 210.

After an adaptive experiment is defined, the adaptive experiment can be started to determine which configurations for contexts associated with a parameter are likely to improve one or more metrics associated with an objective of the adaptive experiment. In some embodiments, there can be a test phase or a review phase prior to starting the experiment. For example, a test run can be performed for the adaptive experiment with a test group of users. The adaptive experiment can be performed in sequence in multiple sessions. There can be a period of time between each session (e.g., a day, a week, a month, etc.). A relevant user population can be determined for the adaptive experiment, and a group of users from the relevant user population can be included in each session. The adaptive experiment can be performed until certain conditions are met or the adaptive experiment is stopped. For example, the adaptive experiment can be performed until all users in the relevant user population are included in the adaptive experiment. In some embodiments, the adaptive experiment can be based on Gaussian processes and Bayesian optimizations.

The configuration generation module 204 can generate configurations of parameter values for categories of a context associated with a parameter to test in a session of the adaptive experiment. If a parameter has multiple contexts associated with it and each context has multiple categories, there can be a large number of configurations to test. Accordingly, the configuration generation module 204 can select a subset of possible configurations for each session of the adaptive experiment. In an initial session, the configuration generation module 204 can generate the configurations completely randomly. In subsequent sessions, the configuration generation module 204 can generate configurations in a manner so that the generated configurations are likely to improve a metric associated with the objective. For example, the configurations can be generated based on performance data of the metric from previous sessions. The generated configurations can be stored using data structures, such as lookup tables, trees, etc.

If a context has a hierarchically higher level context, the configuration generation module 204 can generate configurations for the context for each category of the hierarchically higher level context. For example, for a network connection quality context that has a country context as a hierarchically higher level context, the configuration generation module 204 can generate configurations of parameter values for categories of the network connection quality context for each category of the country context.

The configuration generation module 204 can determine weights associated with the generated configurations. A weight associated with a configuration can indicate a probability of the configuration improving the metric. In the initial session, the weights associated with the generated configurations for the session can be equal. In the subsequent sessions, the weights can be determined based on the performance data of the metric from the previous sessions.

The configuration generation module 204 can generate configurations in an intelligent manner. Generating configurations completely randomly may not provide configurations that are more most likely to improve the metric. Accordingly, the configuration generation module 204 can generate configurations such that the generated configurations are more evenly distributed in a space of possible configurations. For example, constraints can be specified to reduce a space of possible configurations to a subset of the space of possible configurations, and configurations can generated from this subset.

The context resolution module 206 can resolve contexts for users. As explained above, the context resolution module 206 can map a context to a particular parameter value or a particular set of configurations in order to resolve the context. The context resolution module 206 can resolve the context for each user included in the adaptive experiment, for example, during a session. For each user, the context resolution module 206 can determine a particular category of the context with which the user is associated, for example, based on criteria associated with the particular category. Then, for each user, the context resolution module 206 can map the context to a parameter value or one or more configurations for the particular category associated with the user. The context resolution module 206 can resolve contexts according to decision rules. A decision rule can indicate how to resolve a context. For example, the decision rule can indicate how to map a context to a parameter value or one or more configurations. The context resolution module 206 can resolve contexts using data structures that store configurations associated with the contexts, such as lookup tables, trees, etc. As mentioned above, static contexts can be resolved prior to dynamic contexts. Also, hierarchically higher level contexts can be resolved before hierarchically lower level contexts.

Static contexts can be resolved prior to runtime. For example, the country context can be resolved prior to runtime based on a user's country. If categories of the country context include Country 1 and Country 2, the country context for a user in Country 1 can be mapped to one or more configurations of the network connection quality context assigned to Country 1 category, and the country context for a user in Country 2 can be mapped to one or more configurations of the network connection quality context assigned to Country 2 category. If more than one configuration is assigned to a category of a context, one of the configurations for the category can be selected for a user. For example, one of the configurations for the category can be randomly assigned, e.g., by the random assignment module 208 explained below.

Dynamic contexts can be resolved at runtime. For example, the network connection quality context for a user can be resolved on a device of the user at runtime by referring to runtime conditions. A configuration of the network connection quality context from resolving the country context can be sent to the user device, and the network connection quality context can be resolved by determining a category of the network connection quality context the user is associated with and mapping the context to a parameter value for the category as specified in the configuration. There can be a context resolution module on the user device that can resolve dynamic contexts. For example, the context resolution module on the user device can be implemented as a context resolution module 618 in FIG. 6.

After all contexts associated with a parameter are resolved, a user can be mapped to a single parameter value. If contexts cannot be resolved to provide a single parameter value for a user, a default value of the parameter can be assigned to the user. For example, if a category of one or more contexts cannot be determined for a user, the default value of the parameter can be used.

The random assignment module 208 can assign users in a session to a configuration associated with a context based on a weight associated with the configuration. If there is more than one configuration of a context, one of the configurations can be selected for a user. For example, after the country context is resolved to multiple configurations associated with the network connection quality context, the random assignment module 208 can assign one of the multiple configurations to a user. Each configuration of a context can be associated with a weight as explained above. A configuration of a context can be assigned to a proportion or a percentage of users in a session that corresponds to the weight associated with the configuration. For example, if the weight associated with the configuration is 0.3, the configuration can be assigned to 30% of the users in the session. If a configuration of a context is assigned to a category of a hierarchically higher level context, the random assignment module 208 can apply the weight associated with the configuration to users in the session that are associated with the category of the hierarchically higher level context. For example, if a configuration of the network connection quality is assigned to Country 1 category of the country context, the weight associated with the configuration can be applied to users associated with Country 1 category. Accordingly, the configuration can be assigned to a proportion of users associated with Country 1 category that corresponds to the weight associated with the configuration. The random assignment module 208 can randomly assign a user to a configuration of a context. For example, a user can be assigned to a configuration by mapping a user identifier (ID) associated with the user to the configuration. In some embodiments, the random assignment module 208 may consider information relating to contexts in randomly assigning a user to a configuration, such as categories associated with contexts.

The data collection analysis module 210 can obtain performance data relating to the metric associated with the objective. The data collection analysis module 210 can obtain data relevant to measuring performance of the metric from users. The data collection analysis module 210 can obtain the data from users for each session. For example, if the metric associated with the objective is the number of likes, the data collection analysis module 210 can obtain data relating to the number of likes for the users included in the session. The data from users for each session can be aggregated and analyzed in order to determine which configurations are likely to improve the metric. For example, the data from users can be fit to one or more statistical models. The data collection analysis module 210 can use statistical models to make predictions as to which configurations are likely to improve the metric. If configurations of a context are assigned to categories of a hierarchically higher level context, the data from users for each session can be aggregated and analyzed based on the categories of the hierarchically higher level context. For example, data from users associated with Country 1 category of the country context can be obtained and analyzed separately from data from users associated with Country 2 category of the country context. The data from users for each session can be provided to the configuration generation module 204, and the configuration generation module 204 can generate new configurations for a subsequent session of the adaptive experiment based on the data. The configuration generation module 204 can also determine weights for the new configurations based on the data.

Sessions in the adaptive experiment can repeat in this manner until the adaptive experiment is completed or stopped. The adaptive experiment can be completed when certain conditions are satisfied. Such condition can include all users in the relevant user population being included in the adaptive experiment, reaching a certain level of optimization with respect to the metric, etc. After the adaptive experiment is completed or stopped, the adaptive experiment can be restarted at a later point in time, for example, to include additional users or additional configurations associated with contexts. Additional configurations can become available when contexts and/or categories of contexts change for the adaptive experiment. All examples herein are provided for illustrative purposes, and there can be many variations and other possibilities.

An adaptive experiment can explore a small subset of configurations in several sessions to determine configurations that improve or are likely to improve a metric associated with an objective of the adaptive experiment. An adaptive experiment can determine which configurations to test in a session by making predictions about configurations based on performance data from previous sessions and statistical models. In this manner, an adaptive experiment can efficiently test a space of possible configurations over a few sessions without having to explore all possible configurations.

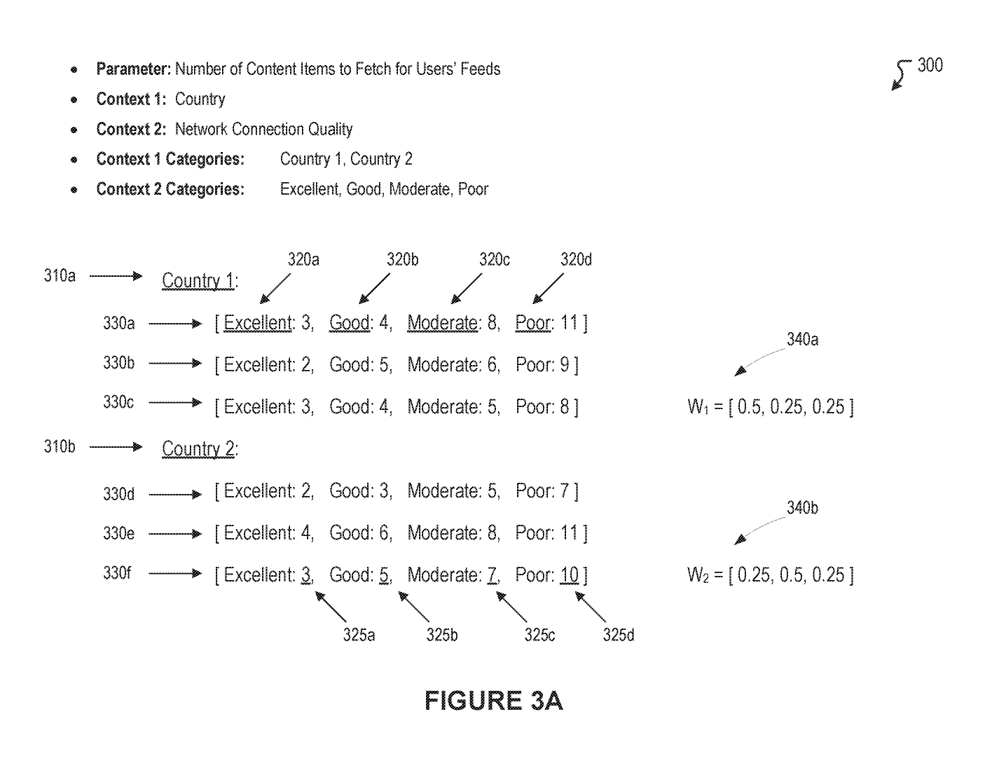

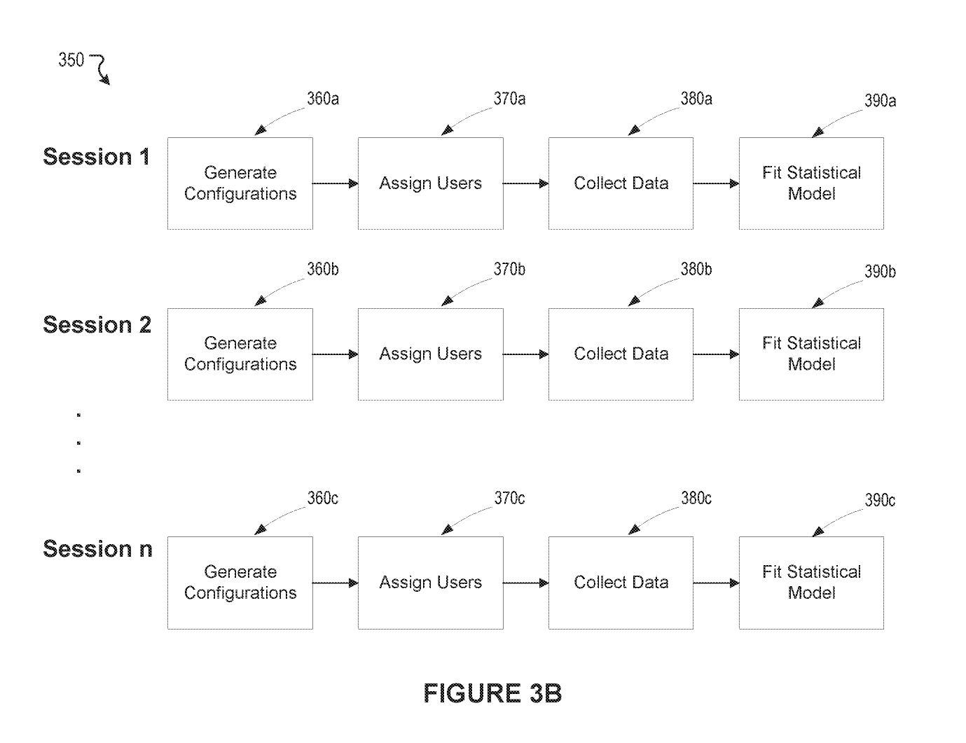

FIG. 3A illustrates an example scenario 300 for providing configurations associated with contexts, according to an embodiment of the present disclosure. In the example of FIG. 3A, a parameter used in a social networking system can be a number of content items to fetch (e.g., prefetch) for users' feeds. There can be two contexts associated with the parameter: Context 1 and Context 2. Context 1 can be a context for a user's country, and Context 2 can be a context for a user's network connection quality. Context 1 has two categories associated with it: Country 1 and Country 2. Context 2 has four categories associated with it: Excellent category, Good category, Moderate category, and Poor category. Context 1 is defined at a hierarchically higher level than Context 2, and each category of Context 1 is assigned one or more configurations of parameter values for categories of Context 2.

The example scenario 300 illustrates example configurations 330 associated with Context 1 and Context 2. Country 1 category 310a of Context 1 is assigned configurations 330a, 330b, 330c of Context 2. Country 2 category 310b of Context 1 is assigned configurations 330d, 330e, 330f of Context 2. Configurations 330 for Country 1 category 310a and configurations 330 for Country 2 category 310b can be different. Each configuration 330 specifies a parameter value for each category of Context 2. The parameter value relates to the number of content items to fetch for users' feeds. For example, a configuration 330 specifies a parameter value 325a for Excellent category 320a, a parameter value 325b for Good category 320b, a parameter value 325c for Moderate category 320c, and a parameter value 325d for Poor category 320d. In the configuration 330a, the parameter value 325a for Excellent category 320a is 3, the parameter value 325b for Good category 320b is 4, the parameter value 325c for Moderate category 320a is 8, and the parameter value 325d for Poor category 320d is 11.

Since more content items can be downloaded readily when the network connection quality is good, a higher number of content items can be fetched for lower network connection quality states than higher network connection quality states. Accordingly, the parameter value 325a for Excellent category 320a can be low compared to the parameter value 325d for Poor category 320d, the parameter value 325c for Moderate category 320c, and so forth. In some embodiments, a higher number of content items can be fetched for higher network connection quality states than lower network connection quality states. In such cases, the parameter value 325a for Excellent category 320a can be higher than the parameter value 325d for Poor category 320d, the parameter value 325c for Moderate category 320c, and so forth.

Each configuration 330 can have a weight associated with it. The example scenario 300 provides a set of weights W₁ 340a for configurations 330a, 330b, 330c assigned to Country 1 category 310a and a set of weights W₂ 340b for configurations 330d, 330e, 330f assigned to Country 2 category 310b. For example, the weight associated with the configuration 330a is 0.5, the weight associated with the configuration 330b is 0.25, and the weight associated with the configuration 330c is 0.25. The configuration 330a can be randomly assigned to 50% of users associated with Country 1 category 310a. Similarly, the configuration 330b can be randomly assigned to 25% of the users associated with Country 1 category 310a.

When a session of the adaptive experiment is started, users included in the first session can be randomly assigned to the configurations 330 based on the weight associated with the configurations 330. When a user is assigned to a configuration 330, the context can be resolved for the user. For example, if a user is in Country 1 and has a network connection quality that is excellent, the user can be assigned one of the configurations 330a, 330b, 330c for Country 1 category 310a. If the user is assigned the configuration 330a, the context for the user can be mapped to the parameter value 325a of Excellent category 320a in the configuration 330a. Therefore, the context for the user can be resolved to 3.

FIG. 3B illustrates an example scenario 350 for providing adaptive experiments associated with a social networking system, according to an embodiment of the present disclosure. The example scenario 350 illustrates multiple sessions of an adaptive experiment performed over time. In the example of FIG. 3B, the sessions of the adaptive experiment include Session 1 through Session n. During each session, configurations are generated, the configurations are assigned to users, data relating to performance of the configurations is collected, and the collected data is fit to one or more statistical models and analyzed. For example, during Session 1, configurations are generated at block 360a, the generated configurations are assigned to users at block 370a, data relating to performance of the configurations is collected at block 380a, and the collected data is fit to one or more statistical models and analyzed at block 390a. Similarly, during Session 2, configurations are generated at block 360b, the generated configurations are assigned to users at block 370b, data relating to performance of the configurations is collected at block 380b, and the collected data is fit to one or more statistical models and analyzed at block 390b. At block 360b, the configurations for Session 2 can be generated based on the analyzed data from Session 1 at block 390a. The process can be repeated for each session. During Session n, configurations are generated at block 360c, the generated configurations are assigned to users at block 370c, data relating to performance of the configurations is collected at block 380c, and the collected data is fit to one or more statistical models and analyzed at block 390c.

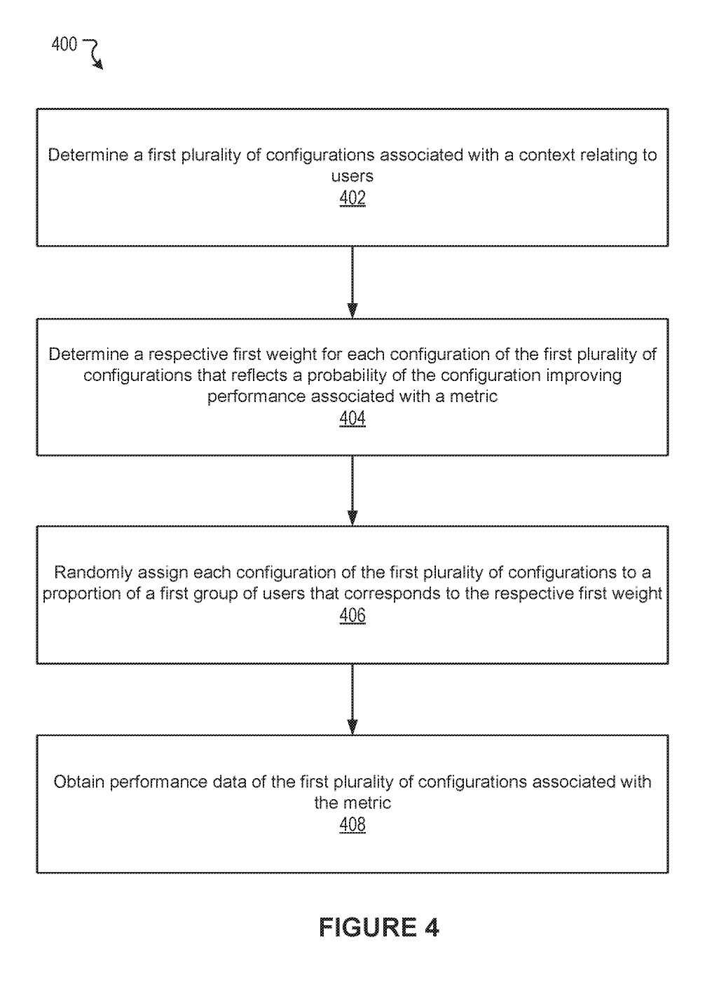

FIG. 4 illustrates an example first method 400 for providing adaptive experiments associated with a social networking system, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can determine a first plurality of configurations associated with a context relating to users. At block 404, the example method 400 can determine a respective first weight for each configuration of the first plurality of configurations that reflects a probability of the configuration improving performance associated with a metric. At block 406, the example method 400 can randomly assign each configuration of the first plurality of configurations to a proportion of a first group of users that corresponds to the respective first weight. At block 408, the example method 400 can obtain performance data of the first plurality of configurations associated with the metric. Other suitable techniques that incorporate various features and embodiments of the present disclosure are possible.

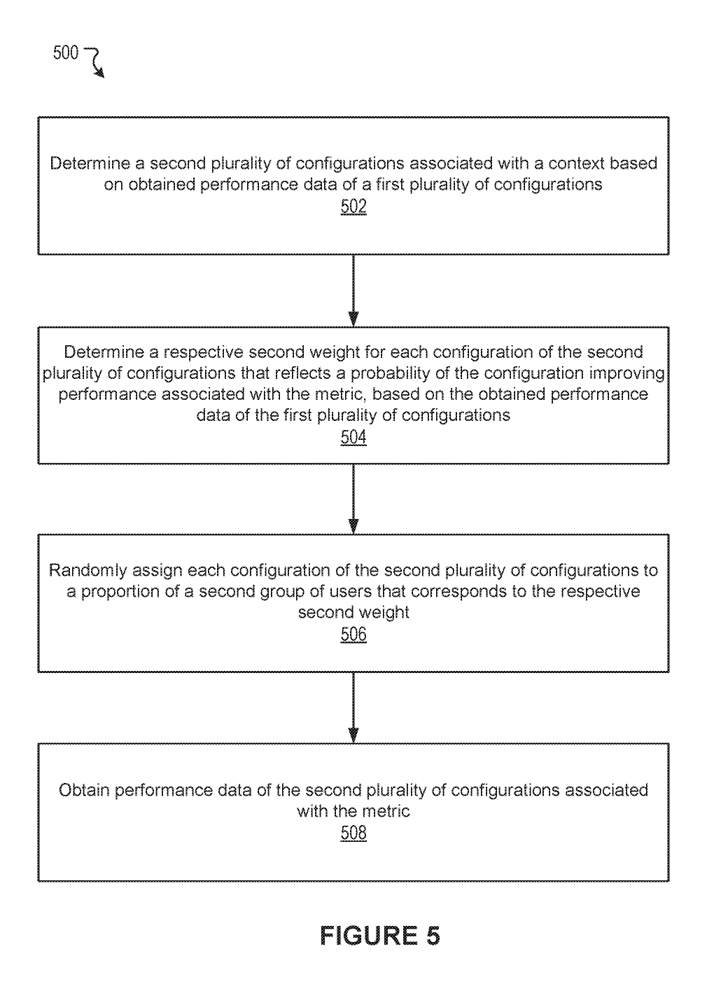

FIG. 5 illustrates an example second method 500 for providing adaptive experiments associated with a social networking system, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can determine a second plurality of configurations associated with a context based on obtained performance data of a first plurality of configurations. The context can be similar to the context explained in connection with FIG. 4. The first plurality of configurations can be similar to the first plurality of configurations explained in connection with FIG. 4. The obtained performance data can be similar to the obtained performance data explained in connection with FIG. 4. At block 504, the example method 500 can determine a respective second weight for each configuration of the second plurality of configurations that reflects a probability of the configuration improving performance associated with the metric, based on the obtained performance data of the first plurality of configurations. At block 506, the example method 500 can randomly assign each configuration of the second plurality of configurations to a proportion of a second group of users that corresponds to the respective second weight. At block 508, the example method 500 can obtain performance data of the second plurality of configurations associated with the metric. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an adaptive experiment module 646. The adaptive experiment module 646 can be implemented with the adaptive experiment module 102, as discussed in more detail herein. In some embodiments, one or more functionalities of the adaptive experiment module 646 can be implemented in the user device 610. In certain embodiments, the user device 610 can include a context resolution module 618. The context resolution module 618 can resolve contexts on the user device 610 as explained above.

### Hardware Implementation

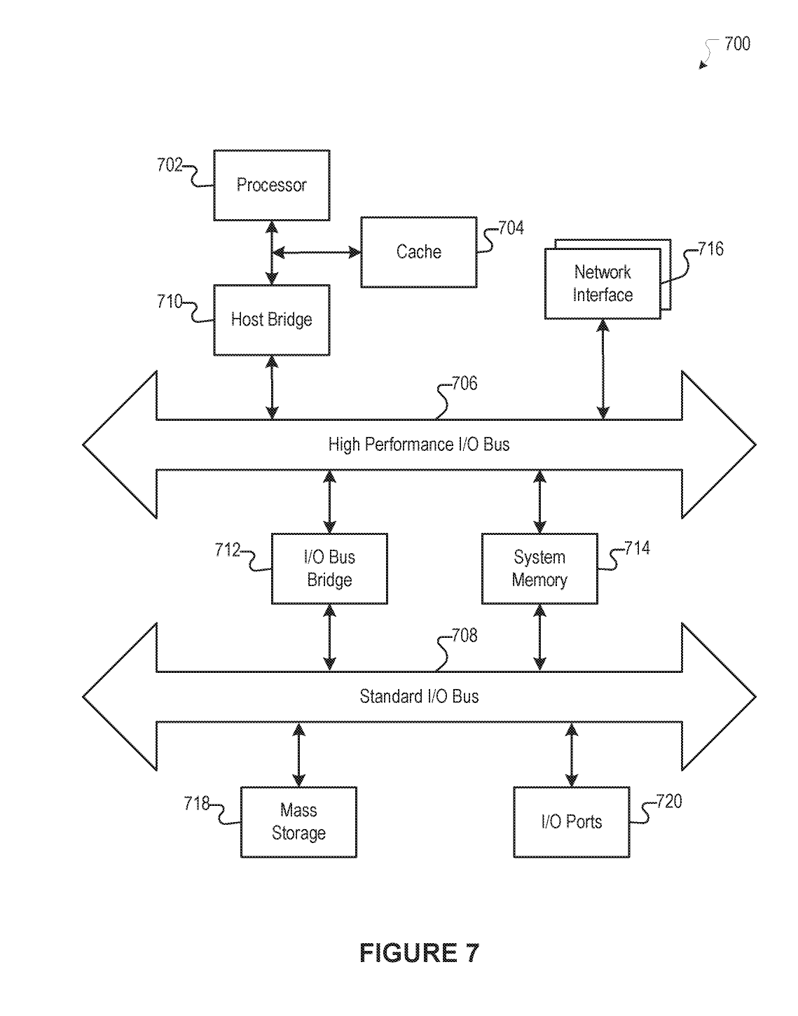

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, a first plurality of configurations associated with a context relating to users;
determining, by the computing system, a respective first weight for each configuration of the first plurality of configurations that reflects a probability of the configuration improving performance associated with a metric;
randomly assigning, by the computing system, each configuration of the first plurality of configurations to a proportion of a first group of users that corresponds to the respective first weight; and
obtaining, by the computing system, performance data of the first plurality of configurations associated with the metric.

2. The computer-implemented method of claim 1, further comprising:
determining a second plurality of configurations associated with the context based on the obtained performance data of the first plurality of configurations;
determining a respective second weight for each configuration of the second plurality of configurations that reflects a probability of the configuration improving performance associated with the metric, based on the obtained performance data of the first plurality of configurations;
randomly assigning each configuration of the second plurality of configurations to a proportion of a second group of users that corresponds to the respective second weight; and
obtaining performance data of the second plurality of configurations associated with the metric.

3. The computer-implemented method of claim 1, wherein the context is associated with a parameter and a value of the parameter is selected from a plurality of possible values.

4. The computer-implemented method of claim 3, wherein a plurality of categories is associated with the context, and wherein a configuration specifies a value of the parameter for each of the plurality of categories associated with the context.

5. The computer-implemented method of claim 4, wherein the first plurality of configurations is a subset of configurations that are possible based on the plurality of possible values of the parameter for each of the plurality of categories associated with the context.

6. The computer-implemented method of claim 4, wherein the second plurality of configurations is a subset of configurations that are possible based on the plurality of possible values of the parameter for each of the plurality of categories associated with the context, and wherein the second plurality of configurations is different from the first plurality of configurations.

7. The computer-implemented method of claim 4, wherein a constraint associated with the parameter identifies a subset of configurations that are possible based on the plurality of possible values of the parameter for each of the plurality of categories associated with the context, and the first subset of configurations is selected from the identified subset.

8. The computer-implemented method of claim 4, further comprising resolving the context for a user in the first group of users by associating the user with one of the plurality of categories associated with the context and assigning to the context the value of the parameter for the associated category specified in the configuration assigned to the user.

9. The computer-implemented method of claim 1, further comprising analyzing the obtained performance data of the first plurality of configurations associated with the metric based on a statistical model.

10. The computer-implemented method of claim 1, wherein the context relates to one or more of: a geographical region of a user, a network connection quality of a user, or a device of a user.

11. A system comprising:
at least one hardware processor; and
a memory storing instructions that, when executed by the at least one processor, cause the system to perform:
determining a first plurality of configurations associated with a context relating to users;
determining a respective first weight for each configuration of the first plurality of configurations that reflects a probability of the configuration improving performance associated with a metric;
randomly assigning each configuration of the first plurality of configurations to a proportion of a first group of users that corresponds to the respective first weight; and
obtaining performance data of the first plurality of configurations associated with the metric.

12. The system of claim 11, wherein the instructions further cause the system to perform:
determining a second plurality of configurations associated with the context based on the obtained performance data of the first plurality of configurations;
determining a respective second weight for each configuration of the second plurality of configurations that reflects a probability of the configuration improving performance associated with the metric, based on the obtained performance data of the first plurality of configurations;
randomly assigning each configuration of the second plurality of configurations to a proportion of a second group of users that corresponds to the respective second weight; and
obtaining performance data of the second plurality of configurations associated with the metric.

13. The system of claim 11, wherein the context is associated with a parameter and a value of the parameter is selected from a plurality of possible values.

14. The system of claim 13, wherein a plurality of categories is associated with the context, and wherein a configuration specifies a value of the parameter for each of the plurality of categories associated with the context.

15. The system of claim 14, wherein the first plurality of configurations is a subset of configurations that are possible based on the plurality of possible values of the parameter for each of the plurality of categories associated with the context.

16. A non-transitory computer readable medium including instructions that, when executed by at least one hardware processor of a computing system, cause the computing system to perform a method comprising:
determining a first plurality of configurations associated with a context relating to users;
determining a respective first weight for each configuration of the first plurality of configurations that reflects a probability of the configuration improving performance associated with a metric;
randomly assigning each configuration of the first plurality of configurations to a proportion of a first group of users that corresponds to the respective first weight; and
obtaining performance data of the first plurality of configurations associated with the metric.

17. The non-transitory computer readable medium of claim 16, wherein the method further comprises:
determining a second plurality of configurations associated with the context based on the obtained performance data of the first plurality of configurations;
determining a respective second weight for each configuration of the second plurality of configurations that reflects a probability of the configuration improving performance associated with the metric, based on the obtained performance data of the first plurality of configurations;
randomly assigning each configuration of the second plurality of configurations to a proportion of a second group of users that corresponds to the respective second weight; and
obtaining performance data of the second plurality of configurations associated with the metric.

18. The non-transitory computer readable medium of claim 16, wherein the context is associated with a parameter and a value of the parameter is selected from a plurality of possible values.

19. The non-transitory computer readable medium of claim 18, wherein a plurality of categories is associated with the context, and wherein a configuration specifies a value of the parameter for each of the plurality of categories associated with the context.

20. The non-transitory computer readable medium of claim 19, wherein the first plurality of configurations is a subset of configurations that are possible based on the plurality of possible values of the parameter for each of the plurality of categories associated with the context.
